(19) United States
(12) Patent Application Publication
(10) Pub. No.: US 2020/0342785 A1
(43) Pub. Date: Oct. 29, 2020

(54) 3D printed personalized nasal replica and attachments to visualize and optimize nasal sinus irrigation strategy

(71) Applicant: Kai Zhao, Dublin, OH (US)

(72) Inventor: Kai Zhao, Dublin, OH (US)

(21) Appl. No.: 16/857,904

(22) Filed: Apr. 24, 2020

Related U.S. Application Data
(60) Provisional application No. 62/839,423, filed on Apr. 26, 2019.

(51) Int. Cl. G09B 23/28

(52) U.S. Cl. CPC G09B 23/285

(57) ABSTRACT

The invention discloses a 3D printed nasal sinus drug delivery device setup. The device includes a nasal cast model that were 3D printed based on individual patient's CT scan, and a delivery set up that comprises rubber/silicon molds that water-tightly connect common irrigation devices to the nasal cast model, as well as colored food dye added to the water for better visualization of irrigation results. The setup will allow patients to perform nasal irrigation trials on their own in home settings that can define optimal parameters according to the personal disease characteristics to achieve personalized optimal irrigation and drug delivery outcome. The setup has the advantages that once optimal irrigation delivery parameter is achieved, it can be record and implemented by the patient so that the treatment outcome can be improved. The use of the invention is convenient, fast, and noninvasive; no toxic or side effects exist.

This non-provisional patent application claims the benefit of one prior-filed provisional application: U.S. 62/839,423.

### BACKGROUND OF THE INVENTION

### Field of the Invention

The present invention relates to the field of medical products, particularly relates to methodology of 3D printed nasal model to optimize nasal sinus irrigation strategy.

Chronic rhinosinusitis (CRS) is one of the most common medical conditions in the US, affecting an estimated 13% of adults, or some 30 million people. It accounts for 12.5 million physician office visits each year and an annual health expenditure of $5.8 billion (National Health Interview Survey 2009, CDC). Topical therapies play an integral role in the management of CRS, and high-volume irrigation delivery (e.g., neti pot, squeeze bottles) are more effective for achieving distribution to the sinuses than other topical delivery methods such as nasal sprays, nebulizers, or atomizers¹⁻⁵. Saline irrigations have been recommended in a number of clinical scenarios, including initial management of CRS⁶ and postoperative care⁷. High-volume irrigations have also shown benefits for medication delivery, such as with mupirocin⁸ and corticosteroids^{3,9,10}. However, due to the intricate and variable anatomy of the human nasal airway, the efficacy of topical irrigations to reach targeted sinuses is inconsistent and difficult to predict. Previous studies have shown that nasal irrigants may not reliably penetrate all sinuses¹¹, and the effectiveness varies depending on specific sinuses, head positions, injection angle, pressure, flow rates, and other factors¹². We currently do not have a clear understanding of the optimal delivery technique(s). There could also be significant individual variabilities that one set of condition works perfect for one patient but not for the other patient.

Investigations into determining the distribution of irrigations within the sinuses have been limited by labor-intensive methodologies, such as cadaver studies or using colored dyes under endoscopic view^{11,12}, using iodinated contrast followed by computed tomography (CT) scans^{2,10}, or using technetium 99m sulfur colloid¹ and fluorescein¹³ labeling. These labor-intensive techniques with significant cost and risk are difficult to apply to the general patient population. From both patients' and clinicians' perspectives, the lack of clear prediction of patient-specific irrigation outcome can be frustrating, as clinicians prescribe a rigorous daily irrigation routine but have no assurance that what patients are doing is effective. When symptoms fail to improve after courses of irrigation, it is difficult to determine whether the irrigation itself is not working, or the irrigation does not reach clinically relevant targets within the sinuses. Many patients and surgeons thus opt for systemic medication or surgery, which increases risk of overmedication, growth of resistant organisms, systemic side effects and serious risk from surgery.

3D printing technology is an additive manufacturing process. Currently, there is no reported use of 3D printing techniques to optimize nasal sinus irrigation outcome. The present invention cover the methodology to convert the CT scan into a nasal model with three-dimensional patient specific features through 3D computer-aided design software; 3D printer will then be used to printed material into a suitable three-dimensional designed object for optimizing personal nasal sinus irrigation strategy.

### BRIEF SUMMARY OF THE INVENTION

Accordingly, the present invention is directed to 3D printed patient-specific nasal replicas based on individual patient's CT scans so that patients can administer irrigation techniques themselves on the replicas to determine the optimal personalized nasal irrigation strategy (head positions, the angle of injection, flow rates, etc.).

An advantage of 3D printed nasal replica over other techniques is that it is less labor-intensive and requiring only a CT scan and assess to 3D printer. This can save a significant amount of time compared with using radio-active tracing or endoscope visualizing, and it causes no discomfort to the patients and is patient specific.

In another aspect of the present invention, further embodiments of various methods of rubber/silicon molds that will water-tightly connect common irrigation devices to the nose model, as well as colored food dye added to the water for better visualization of irrigation results are described.

In another aspect of the present invention, a partial face (external nose) will be printed to allow for better orientation of the face. A mobile app may allow the patients to take picture of the final optimal nose position, then allow for matching head position against the nose model through overlapping of camera feed and the stored nose position. Colored dots will be used as markings for different sinuses. Multiple dots can be used on each sinus to indicate the range of inflammation and irrigation targets.

Further embodiments, features, and advantages of 3D printing, as well as the structure and operation of the various embodiments of the 3D printed nasal replica and attachment, are described in detail below with reference to the accompanying drawings.

It is to be understood that both the foregoing general description and the following detailed description are exemplary and explanatory only and are not restrictive of the invention as claimed.

### BRIEF DESCRIPTION OF THE DRAWINGS

The accompanying figures, which are incorporated herein and form part of the specification, illustrate nasal cavity 3D printing according to principles of the present invention. Together with the description, the figures further serve to explain the principles of the nasal 3D printing described herein and thereby enable a person skilled in the pertinent art to make and use the 3D printing of nasal replica. The patent or application file contains at least one drawing executed in color.

FIG. 1 shows a 3D printed nasal replica of one individual patient according to principles of the present invention. We invented methodology to convert patient's CT scan into patient specific nasal replicas.

FIG. 2 shows a cross-section of the 3D replica. A wall of 3-4 mm thickness is created to enclose the nasal air space.

FIG. 3 shows how patient can easily performed and practice irrigation trials on the replica of their own noses over a sink with the water-tightly attachment (shown in FIGS. 5, 6, and 7), develop their own personal optimal irrigation strategy (head position, irrigation angle, irrigation flow rate, irrigation devices, etc.) and have visual confirmation at home.

FIG. 4, we have further validation of such irrigation trials against previously published computational simulation results on the same patient, and the results matched very well with each other.

FIGS. 5, 6, and 7 demonstrate another aspect of the present invention that involves various attachments of water-tightly connection for common irrigation devices to the nose model. They all serve similar function to water-tight connecting the irrigation device to the nasal replica, so that irrigation trials can be easily performed over a sink, as shown in FIG. 3.

FIG. 5. is an example of rubber molds hot glued onto a squeeze bottle,

FIG. 6. is an example of silicon deformable molds attached to a squeeze bottle.

FIG. 7. is a similar example of silicon deformable molds attached a typical net-pot.

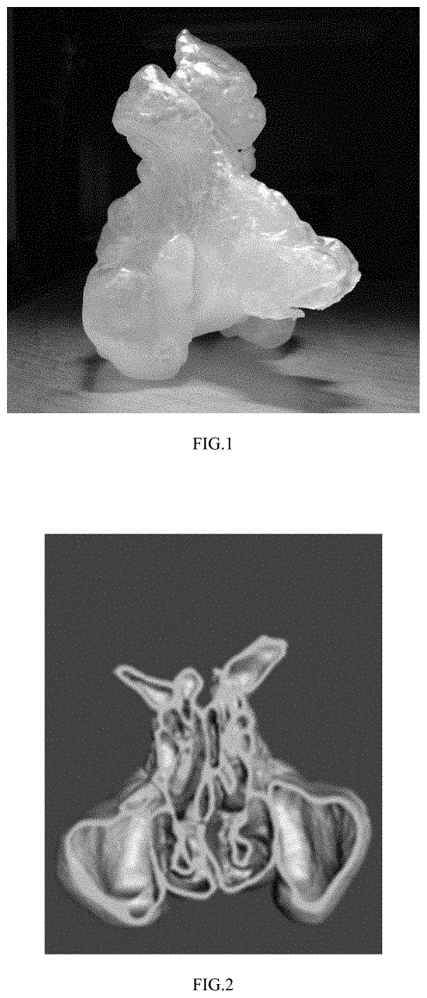

### DETAILED DESCRIPTION OF THE INVENTION

Reference will now be made in detail to embodiments of the 3D printed nasal replica and attachment with reference to the accompanying figures.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

Chronic Rhinosinusitis (CRS) significantly impacts patient quality of life and affects sleep- and productivity-related outcomes. A critical gap in current treatment of CRS is the lack of understanding of patient specific optimal delivery parameters(s) for sinus irrigations. There is evidence that if sufficient drug or irrigation can be appropriately delivered to the targeted sinuses, majority of CRS symptoms can be significantly improved without the need for surgery and systematic medication (Harvey et al., 2018). We show in previous studies that significant variability exists in the irrigation outcome, depending on the individual anatomy, with head position, irrigation angle and flow rates being important factors to consider. For example, we showed that one set of parameter may work perfectly for one patient pre-surgery, but not necessary well for the same patient post-surgery. We showed that disruption of the normal nasal structures by certain intuitive surgical maneuvers do not necessarily improve irrigation outcome—even can cause unexpected reduction of irrigation to sinuses. Accordingly, the present invention is directed to 3D printed patient-specific nasal replicas based on individual patient's CT scans so that patients can administer irrigation techniques themselves on the replicas to determine the optimal personalized nasal irrigation strategy (head positions, the angle of injection, flow rates, etc.). An advantage of 3D printed nasal replica over prior arts is that it is less labor-intensive, requiring only a CT scan and patients can have hands on experience at home over a kitchen sink. This can save a significant amount of time and risk compared with using radio-active tracing or endoscope visualizing, and it causes no discomfort to the patients and is patient specific.

Referring to FIG. 2, according to principles of the present invention, we invented methodology to convert patient's CT scan into patient specific nasal replicas. In brief, first the interface between the nasal mucosa and the air was delineated on the CT scans using an imaging processing software (AMIRA, Visualization Sciences Group, Burlington, Mass.) and it may work with other imaging software for the same principle. We then created a 3-4 mm thickness wall to enclose the nasal air space. We kept both of the nostrils open, where the dye-solution through the irrigation device opening would be forced into one nostril at different flow rates/angles at the control of the user and the contralateral nostril will serve as an outlet (the only outlet), through which air and saline could exit. The nasopharyngeal opening was blocked off and impenetrable to liquid or air, representing the closure of the soft palate. The nostril planes were specially treated to be flat and smooth that allowed for better water-tight fitting with the delivery attachment. 3D nasal digital model was then saved as STL file, and sent to a 3D printer. We used a Formlabs Form 2 Stereolithography (SLA) 3D Printer to print out the nasal replica, as it can print semi-transparent material. We are certainly sure that other 3D printing technologies are also suitable for this need following the same principle.

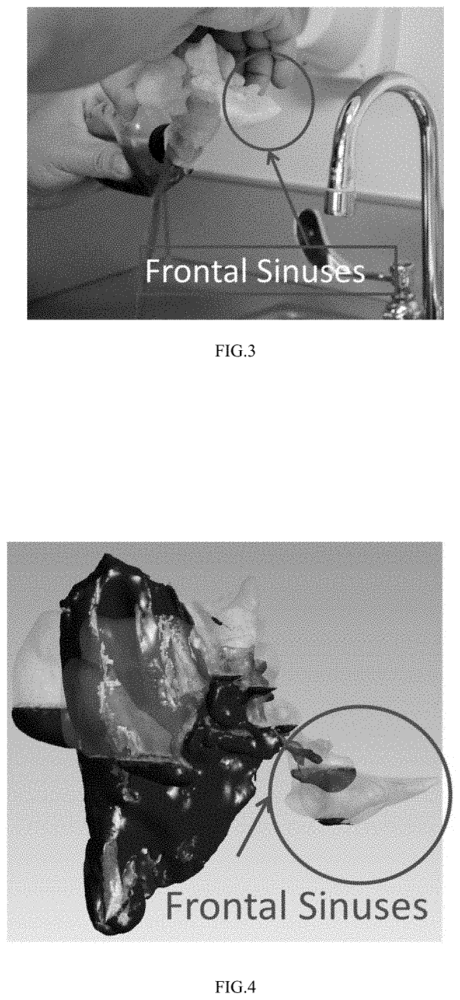

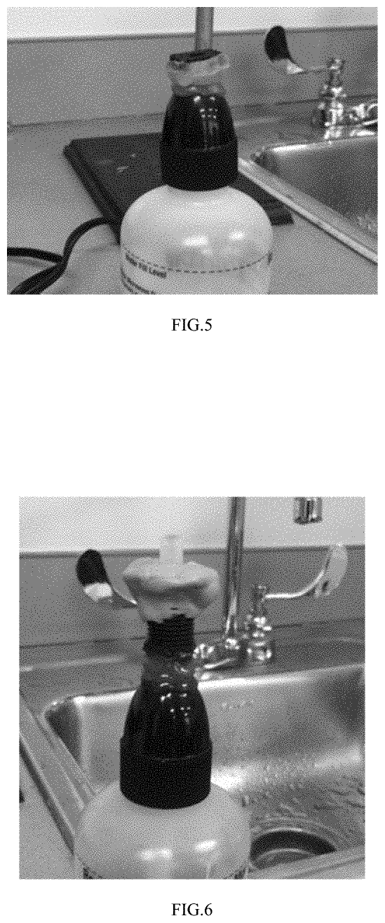

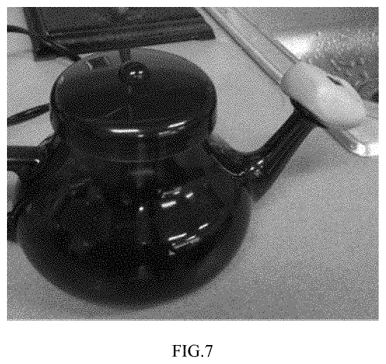

Another aspect of the present invention, involves various attachment of water-tightly connection of common irrigation devices to the nose model, as well as colored food dye added to the water for better visualization of irrigation results. We showed that as examples, we can use rubber molds hot glued onto a squeeze bottle (FIG. 5), silicon deformable and detachable molds on a squeeze bottle (FIG. 6), and similar silicon molds on a typical net-pot (FIG. 7). They all serve similar function to water-tight connecting the irrigation device to the nasal replica, so that irrigation trials can be easily performed over a sink, as shown in FIG. 3. We have further validation of such irrigation trials against previously published computational simulation results on the same patient, and the results matched very well with each other (FIGS. 3 and 4).

In another aspect of the present invention, a partial face (external nose) can be printed to allow for better orientation of the face. An app may allow the patient to take picture of the final optimal nose position, and allow for matching head position against the nose model through overlapping of camera feed and the stored nose position. Colored dots will be used as markings for different sinuses. Multiple dots can be used on each sinus to indicate the range of inflammation and the irrigation targets based on clinicians' diagnosis.

Ultimately, the 3D printed nasal replica and delivery attachments allows patients to practice and develop their own personal irrigation strategy and have visual confirmation of how irrigation reaches the irrigation targets on the model at home. This would be valuable for patients in rural areas or in disadvantaged communities without access to advance medical resources, and it also serves as an important patient education tool. One problem with nasal irrigation is patient compliance, since the irrigation is not an entirely pleasant experience. With visual confirmation, patients would have increased confidence and motivation to follow through with daily prescribed irrigation routines. In the foreseeable future, with more affordable and widely available 3D printing, tens of thousands of practicing otolaryngologists in the US, as well as millions of patients visiting them annually, may potentially benefit from this invention. On an individual basis, analysis of irrigant flow using the 3D printed models also have the potential to provide insight into what surgical maneuvers may optimize nasal drug delivery and to guide to improve surgical outcome in the future.

While various embodiments of the present invention have been described above, it should be understood that they have been presented by way of example only, and not limitation. It will be apparent to persons skilled in the relevant art that various changes in form and detail can be made therein without departing from the spirit and scope of the present invention. Thus, the breadth and scope of the present invention should not be limited by any of the above-described exemplary embodiments, but should be defined only in accordance with the following claims and their equivalents.
1. Wormald P-J, Cain T, Oates L, Hawke L, Wong I. A comparative study of three methods of nasal irrigation. The Laryngoscope. 2004 December; 114(12):2224-2227. PMID: 15564850
2. Harvey R J, Goddard J C, Wise S K, Schlosser R J. Effects of endoscopic sinus surgery and delivery device on cadaver sinus irrigation. Otolaryngol—Head Neck Surg Off J Am Acad Otolaryngol-Head Neck Surg. 2008 July; 139(1):137-142. PMID: 18585576
3. Harvey R J, Snidvongs K, Kalish L H, Oakley G M, Sacks R. Corticosteroid nasal irrigations are more effective than simple sprays in a randomized double-blinded placebo-controlled trial for chronic rhinosinusitis after sinus surgery. Int Forum Allergy Rhinol. 2018; 8(4):461-470. PMID: 29394004
4. Thomas W W, Harvey R J, Rudmik L, Hwang P H, Schlosser R J. Distribution of topical agents to the paranasal sinuses: an evidence-based review with recommendations. Int Forum Allergy Rhinol. 2013 September; 3(9):691-703. PMID: 23729216
5. Doellman M, Chen P G, McMains K C, Sarber K M, Weitzel E K. Sinus penetration of saline solution irrigation and atomizer in a cadaveric polyp and allergic fungal sinusitis model. Allergy Rhinol Provid RI. 2015 January; 6(1):8-11. PMCID: PMC4388882
6. Achilles N, Mösges R. Nasal saline irrigations for the symptoms of acute and chronic rhinosinusitis. Curr Allergy Asthma Rep. 2013 April; 13(2):229-235. PMID: 23354530
7. Liang K-L, Su M-C, Tseng H-C, Jiang R-S. Impact of pulsatile nasal irrigation on the prognosis of functional endoscopic sinus surgery. J Otolaryngol—Head Neck Surg J Oto-Rhino-Laryngol Chir Cervico-Faciale. 2008 April; 37(2):148-153. PMID: 19128603
8. Jervis-Bardy J, Boase S, Psaltis A, Foreman A, Wormald P-J. A randomized trial of mupirocin sinonasal rinses versus saline in surgically recalcitrant staphylococcal chronic rhinosinusitis. The Laryngoscope. 2012 October; 122(10):2148-2153. PMID: 22865576
9. Jang D W, Lachanas V A, Segel J, Kountakis S E. Budesonide nasal irrigations in the postoperative management of chronic rhinosinusitis. Int Forum Allergy Rhinol. 2013 September; 3(9):708-711. PMID: 23776108
10. Snidvongs K, Kalish L, Sacks R, Sivasubramaniam R, Cope D, Harvey R J. Sinus surgery and delivery method influence the effectiveness of topical corticosteroids for chronic rhinosinusitis: systematic review and meta-analysis. Am J Rhinol Allergy. 2013 June; 27(3):221-233. PMCID: PMC3901441
11. Grobler A, Weitzel E K, Buele A, Jardeleza C, Cheong Y C, Field J, Wormald P-J. Pre- and postoperative sinus penetration of nasal irrigation. The Laryngoscope. 2008 November; 118(11):2078-2081. PMID: 18641522
12. Singhal D, Weitzel E K, Lin E, Feldt B, Kriete B, McMains K C, Thwin M, Wormald P-J. Effect of head position and surgical dissection on sinus irrigant penetration in cadavers. The Laryngoscope. 2010 December; 120(12):2528-2531. PMID: 21058393
13. Bleier B S, Preena D, Schlosser R J, Harvey R J. Dose quantification of topical drug delivery to the paranasal sinuses by fluorescein luminosity calculation. Int Forum Allergy Rhinol. 2012 August; 2(4):316-320. PMID: 22411746

What is claimed is:

1. A device to optimize nasal irrigation drug delivery strategy, prepared by 3D printing, comprised of:
A 3D printed patient-specific nasal replica based on individual patient's CT scan. The thickness of the shell is 2-4 mm, which allows for good visualization of irrigation outcome. Food color is added into the water to enhance visualization; and
A set of rubber or silicone deformable seals to provide water-tight connection for most common irrigation devices, bottles, neti-pots, etc. to the 3D printed nasal replica.

2. The 3D printed replica of claim 1, further comprising a partial face (external nose) for better orientation of the head position and an app allowing the patient to take picture of the final optimal nose position, and to match head position against the nose model through overlapping of camera feed and the stored nose position.

3. The 3D printed replica of claim 1, further comprising colored markings for different sinuses to indicate the range of inflammation, based on clinician's diagnosis, and to serve as targets for patients' irrigation trial: to get the irrigant to these marked region.

4. The water-tight seal of claim 1, further made of different material (rubber, foam, silicon, silicone etc.), strengthened with glue or epoxy, to serve the principle function of connecting irrigation devices (bottles, neti-pots, etc.) to the nasal replica.

5. A method that allows patients to practice irrigation on the replica of their own noses to develop their own personal optimal irrigation strategy (head position, irrigation angle, irrigation flow rate, irrigation devices, etc.) and to have visual confirmation at home.

6. A method that serves as patient education tool on nasal sinus irrigation to provide treatment confidence and to improve patients' compliance to nasal irrigation.
